(19) United States
(12) Patent Application Publication
(10) Pub. No.: US 2007/0066263 A1
(43) Pub. Date: Mar. 22, 2007

(54) Digital Signal Receiver With A Built-In Antenna

(76) Inventors: Chia-Yu Wu, Taipei City (TW); Tzu-Chiang Chu, Taipei County (TW); Ying-Hua Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/465,456

(22) Filed: Aug. 18, 2006

(30) Foreign Application Priority Data
Sep. 21, 2005 (TW) 094216251

(51) Int. Cl. H04B 1/06; H04M 1/00

(52) U.S. Cl. 455/269; 455/575.7

(57) ABSTRACT

An antenna unit, a receiver, and an interface controller are positioned in a case. The antenna unit is for receiving digital television signals and digital broadcasting signals. The receiver is coupled to the antenna unit and includes at lease a tuner for processing signals from the antenna unit. The interface controller is coupled to the receiver for conversion of communicating data.

### BACKGROUND OF THE INVENTION

1. Field of the Invention

The present invention provides a digital signal receiver with a built-in antenna, in particular provides a digital signal receiver and implements an antenna for receiving digital signals in a structure of the digital signal receiver.

2. Description of the Prior Art

A digital signal receiver of the prior art is a digital television or a digital broadcasting receiver box for receiving digital signals from digital television or radio broadcasting stations. In general, a digital signal receiver comprises a tuner, a demodulator, and signal processing circuits. This type of digital signal receiver uses external antennas coupled to the digital signal receiver with cables, so that the antennas are extended and placed in appropriate places to receive corresponding digital signals. However, the external antennas reduce portability of the digital signal receivers due to a need to frequently plug/unplug the cables that coupled the antennas to the digital signal receivers. Therefore the external antennas are inconvenient to use and the cables will get loosen or lost in the long run, which leads to the digital signal receiver not being able to receive at all.

### SUMMARY OF THE INVENTION

A digital signal receiver with a built-in antenna according to the present invention includes an antenna unit for receiving digital television signals or digital broadcasting signals, a receiver coupled to the antenna unit and has a tuner used for processing signals received from the antenna unit, and an interface controller coupled to the receiver for converting data from a first form to a second form; where the antenna unit, the receiver, and the interface controller are placed in a case.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a digital signal receiver with a built-in antenna according to the present invention.

FIG. 2 is a diagram of an embodiment of a digital signal receiver with a built-in antenna according to the present invention.

FIG. 3 is a diagram of another embodiment of a digital signal receiver with a built-in antenna according to the present invention.

FIG. 4 is a diagram of another embodiment of a digital signal receiver with a built-in antenna according to the present invention.

### DETAILED DESCRIPTION

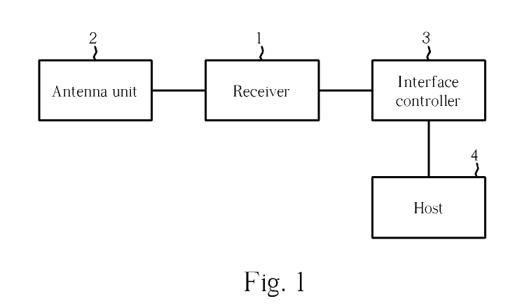

Please refer to FIG. 1. FIG. 1 is a block diagram of a digital signal receiver with a built-in antenna according to the present invention. As presented in FIG. 1, the present invention comprises a receiver 1, an antenna unit 2, and an interface controller 3 for coupling to a host 4. The host 4 is an electronic device comprising functions to play video and audio and is used to play digital signals from the receiver 1. The host can be one of playing devices of a desktop computer, a laptop computer, a Personal Digital Assistant (PDA), and a portable multimedia player.

Of the components comprised in the digital signal receiver described above, the receiver 1 can process digital signals, so that the receiver 1 comprises at least a tuner and a demodulator. The tuner and the demodulator are for processing digital television (like DVB, ATSC) signals and digital broadcasting (like DAB) signals received from the antenna unit 2 and transmitting the received signals to the receiver 1 simultaneously. The interface controller 3 is an interface for data communications and conversion, and the interface controller 3 chooses a protocol from USB, PCMCIA, CF, and SDIO to be a protocol to communicate with the host 4 for signal exchanging.

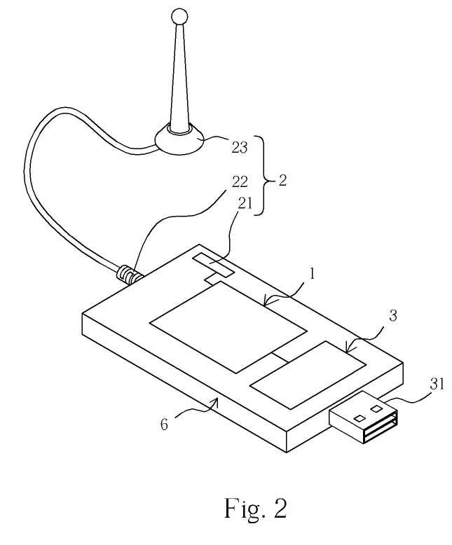

Please refer to FIG. 2. FIG. 2 is a diagram of an embodiment of a digital signal receiver with a built-in antenna according to the present invention. According to description above, the present invention comprises the receiver 1, the antenna unit 2, and the interface controller 3 and can be implemented with electronic circuits and placed on a circuit board 6. The antenna unit 2 comprises a micro antenna 21, and an external antenna connector 22 for connecting an ordinary external antenna 23. The micro antenna 21 and the external antenna connector 23 form an antenna structure corresponding to transmitting frequencies of the DVB and DAB signals. An interface connector 31 is a communications interface connector corresponding to the protocol chosen from USB, PCMCIA, CF and SDIO by the interface controller 3. The interface connector 31 is coupled between the interface controller 3 and the host 4 for playing digital signals provided by the receiver 1.

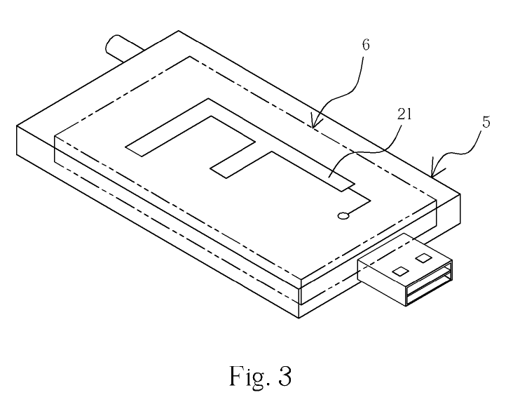

Please refer to FIG. 3. FIG. 3 is a diagram of another embodiment of a digital signal receiver with a built-in antenna according to the present invention. The circuit board 6 described above can be placed in a hollow case 5, while the micro antenna 21 can be placed on a surface of the case 5 and coupled to the circuit board 6. For instance, the micro antenna 21 can be a thin-film antenna made of thin metal film and placed on the surface of the case 5.

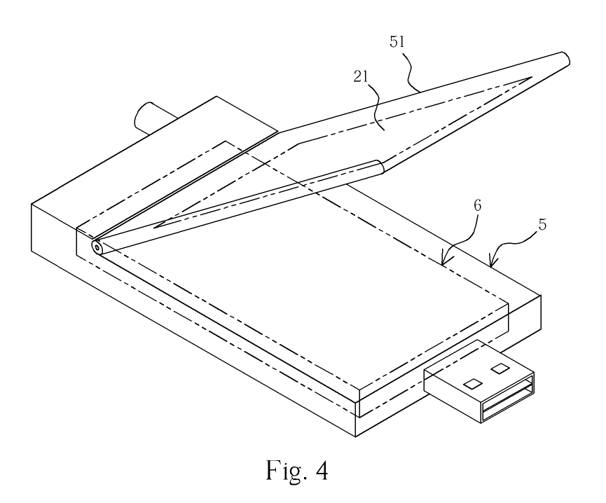

Please refer to FIG. 4. FIG. 4 is a diagram of another embodiment of a digital signal receiver with a built-in antenna according to the present invention. A second case 51 is placed on an outside of the case 5 described above. The second case 51 can be attached to the outside of the case 5 with a joint device. While the joint device is operating, the second case 51 is able to change its orientation to increase a sensitivity of receptions. In addition, the micro antenna 21 can be placed within the second case 51 and coupled to the circuit board 6. For example, the second case 51 is placed on the case 5 with a mobile joint; by adjusting the orientation of the second case 51, a gain field of the micro antenna 21 is changed to have a better position for receptions.

The micro antenna 21 described above is generally implemented with a thin metal film disposed on a base circuit board in a particular pattern, where it can also be constructed with a plurality of layers of base circuit boards stacked together. Additionally, the micro antenna 21 can also be made of piezoelectric ceramic or high-dielectric material through micro-electrical processes to have a specific bandwidth.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A digital signal receiver with a built-in antenna, the digital receiver comprising:
an antenna unit for receiving digital television signals or digital broadcasting signals;
a receiver coupled to the antenna unit and comprising a tuner used for processing signals received from the antenna unit; and
an interface controller coupled to the receiver for converting data from a first form to a second form;
wherein the antenna unit, the receiver, and the interface controller are placed in a case.

2. The digital signal receiver of claim 1 wherein the receiver, the antenna unit, and the interface controller can be implemented with electronic circuits and placed on a circuit board.

3. The digital signal receiver of claim 1 wherein the antenna unit comprises a micro antenna placed inside the case.

4. The digital signal receiver of claim 3 wherein the antenna unit further comprises an external antenna connector used for connecting an external antenna.

5. The digital signal receiver of claim 1 wherein the receiver and the interface controller are placed on a circuit board and the antenna unit comprises a micro antenna and is placed on a surface of the case and coupled to the circuit board.

6. The digital signal receiver of claim 1 wherein the receiver and the interface controller are placed on a circuit board and the antenna unit comprises an antenna made of metal films and is placed on a surface of the case and coupled to the circuit board.

7. The digital signal receiver of claim 1 further comprising a second case placed on a surface of the case and the antenna unit comprises a micro antenna placed inside the second case and coupled to a circuit board where the receiver and the interface controller are disposed.

8. The digital signal receiver of claim 7 wherein the second case is connected to the case with a hinge.

9. The digital signal receiver of claim 1 further comprising a second case placed a surface of the case and the antenna unit comprises an antenna made of metal films placed inside of the second case and coupled to the circuit board where the receiver and the interface controller are disposed.

10. The digital signal receiver of claim 9 wherein the second case is connected to the case with a hinge.

11. The digital signal receiver of claim 1 wherein the interface controller chooses one communication protocol from USB, PCMCIA, CF and SDIO.

12. The digital signal receiver of claim 11 wherein the interface controller comprises at least one interface connector.

13. The digital signal receiver of claim 1 wherein the receiver further comprises a demodulator.
